(19) United States
(12) Patent Application Publication
(10) Pub. No.: US 2012/0265574 A1
(43) Pub. Date: Oct. 18, 2012

(54) CREATING INCENTIVE HIERARCHIES TO ENABLE GROUPS TO ACCOMPLISH GOALS

(75) Inventors: Benjamin P. Olding, San Francisco, CA (US); Nathan Norfleet Eagle, Boston, MA (US)

(73) Assignee: JANA MOBILE, INC., San Francisco, CA (US)

(21) Appl. No.: 13/445,802

(22) Filed: Apr. 12, 2012

Related U.S. Application Data
(60) Provisional application No. 61/474,275, filed on Apr. 12, 2011.

(51) Int. Cl. G06Q 10/06

(52) U.S. Cl. 705/7.14; 705/7.13

(57) ABSTRACT

A job is divided into tasks belonging to various levels in a hierarchy such that the tasks of one level of the hierarchy depend on the performance of the tasks of another level. The divided tasks are assigned to the respondents and, once the respondents' responses have been determined to be sufficiently accurate, the responses are assembled into a final result. The respondents may be rewarded for completion of their assigned tasks, and the rewards may be structured such that the rewards for the completed tasks create an informal hierarchy amongst the respondents.

### CROSS-REFERENCE TO RELATED APPLICATION

This application claims the benefit of U.S. Provisional Application No. 61/474,275, filed Apr. 12, 2011, which is hereby incorporated by reference in its entirety.

### BACKGROUND

This invention relates generally to managing a group of people distributed over electronic communication networks, and more particularly to the automated management of tasks and respondents in a distributed group of people.

Many processes that an organization, such as a business, need to perform can be divided into a number of discrete tasks that must be performed manually. For example, a business may need a human to review and classify a large number of pictures, as this process may not be feasible to perform using a machine. To classify each picture, in this example, a human may use a computer system to access and view each graphical image, determine how to classify the image, and then enter the classification into the computer system. Alternatively, a business may need to gather data about a product, a service or other businesses and a human may be assigned tasks to gather the desired data. The tasks that are required to complete a process may be performed by a single person, who may be an employee of the organization. Alternatively, since the tasks can be discrete, the tasks may be distributed to and performed by a number of different people, and the results of the tasks later combined to complete the process.

In many cases, the local labor that is available to an organization may not always be appropriate for the tasks, depending on the tasks that the organization needs to be performed. For example, local labor may not have used a foreign product or service and may not have the required information or experience regarding the foreign product or service. Some tasks may also require the labor to be present in a foreign country to complete the task (for e.g., marketing a product through distributing published media about the product in the foreign country), and transporting local labor to the foreign country may be cost prohibitive. In a wealthy industrialized country, for example, the local group of people may not be willing to perform relatively small tasks for a relatively small reward, whereas respondents from other areas in the world might be willing to do the task for the compensation that the organization is willing to pay. The proliferation of electronic communication networks, such as the Internet and cellular networks, has increased the availability of respondents who are located remote from the businesses and organizations that could benefit from their labor. Nevertheless, sending tasks to a distributed group of people still presents many logistical issues.

The use of a large group people to perform multiple discrete tasks is often referred to as “crowdsourcing.” Existing crowdsourcing systems typically provide tasks to any anonymous person willing to perform them, so that the crowdsourcing systems have little or no knowledge of the capabilities of these persons. As a result, these systems fail to motivate people to perform tasks well and thus fail to achieve a high quality of results from the contributors. Existing crowdsourcing systems also do not leverage relationships or commonalities that may exist among the people performing tasks. These and other limitations of crowdsourcing have rendered it inappropriate for solving the needs of many organizations that have tasks that must be performed reliably and economically.

### SUMMARY

To allow an organization to use the labor of respondents who are accessible via communication networks, embodiments of the invention provide mechanisms to manage the tasks and the respondents in a distributed group of people. In one embodiment, a system maintains respondent profiles for a number of respondents who have registered with the system. When the system receives a new job, it divides a job into tasks belonging to various levels in a hierarchy such that the tasks of one level of the hierarchy depend on the performance of the tasks of another level of the hierarchy. Dividing a job into tasks within hierarchical levels provides many benefits, such as enabling multiple respondents to work on the same job, maintaining quality control of the task performed by the respondents, using the available resources efficiently, and securing data contained in the tasks. The system then assigns the tasks to the respondents based, at least in part, on information about the respondents, stored in the respondent profile for each of the respondents, and possibly on information about the tasks. The system then sends the assigned tasks over a network to electronic devices associated with the respondents to whom the tasks are assigned. Once the system receives responses for the assigned tasks, the system determines a result based on the received responses and communicates the result to the job provider.

By tracking information about the respondents and assigning the tasks based on information that it knows about the respondents, the system can select the most appropriate respondents to perform any given task. This increases the quality of the respondents' responses and in turn increases the chances of a correct response to the task. In a scheme where the respondents are compensated for their responses, this reduction in the risk of incorrect responses decreases the need to assign additional tasks to respondents to complete the job, thereby reducing the overall expected costs of the job.

### BRIEF DESCRIPTION OF THE DRAWINGS

FIG. 1 illustrates the relationships among various entities in a distributed group of people, in accordance with one embodiment of the invention.

FIG. 2 illustrates a system for managing tasks and respondents in a distributed group of people, in accordance with one embodiment of the invention.

FIG. 3 is a block diagram of the job processor server of FIG. 2, in accordance with one embodiment of the invention.

FIG. 4 is a block diagram of a respondent server of FIG. 2 in accordance with one embodiment of the invention.

FIG. 5 illustrates a process for registering a respondent, in accordance with one embodiment of the invention.

FIGS. 6A and 6B illustrate a process for managing the performance of a job by a distributed group of people, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Management System for a Distributed Group of People

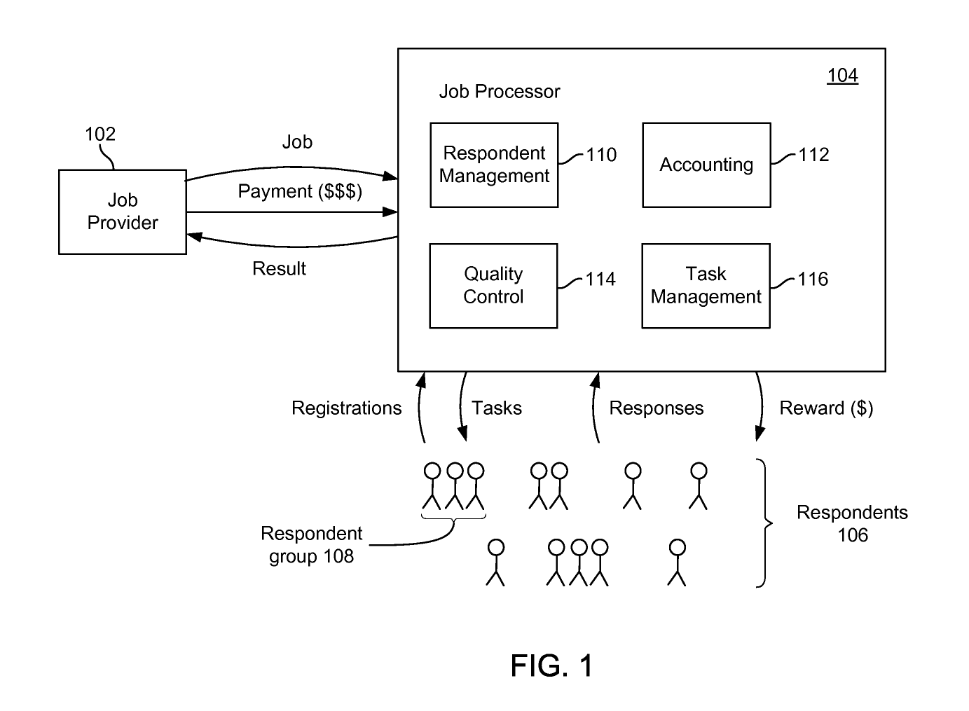

FIG. 1 illustrates the relationships among various entities in one embodiment of a distributed group of people. The distributed group of people can include people, computers, or a combination of people and computers. A job provider 102 sends a job that it desires to have completed to a job processor 104. The job provider 102 may be an individual, organization, business, or any other entity that needs a job to be performed on its behalf. The job processor 104 is an entity that organizes the tasks and their completion on behalf of the job provider 102. The job provider 102 may also submit a payment to the job processor 104 as compensation for performing the job. In one implementation, the job processor 104 is a service provider that offers distributed group of people management services for a number of job providers 102, which are clients of the job processor 104.

The job processor 104 completes jobs for the job provider 102 using respondents 106. The job processor 104 uses a number of systems to carry out its processes, including respondent management 110, quality control 114, accounting 112, and task management 116. After the job provider 102 sends a job to the job processor 104, the job processor 104 divides the job into a number of discrete tasks that can be performed individually and separately. The job processor 104 then assigns the tasks to respondents 106, receives responses (i.e., answers to the assigned tasks) from the respondents 106, and then submits an overall job result to the job provider 102. The job processor 104 keeps track of the individual respondents 106 and has information about the respondents 106 and their past performance of tasks. This information allows the job processor 104 to assign more appropriate tasks to each respondent 106 and thus to achieve a higher quality result for each of the overall jobs.

Respondents 106 receive tasks from the job processor 104, perform the tasks, and submit responses to the job processor 104. Respondents 106 may also initially register with the job processor 104 to enable the job processor 104 to better track and identify the respondents 106. For clarity, in the description below, respondents 106 are considered to be individual persons. These persons may be marketers, salesperson, consumers or other people associated with a product or a service. In other embodiments, a respondent 106 may comprise a group of people, a corporation, or another entity. In other embodiments, the system may also use automatic algorithms (e.g., image recognition routines) to perform some of the tasks that might otherwise be performed by human respondents. Respondents 106 may be divided into respondent groups 108 that share a common connection or property, as described further below. Respondents 106 may be provided with various types of rewards for completing tasks and submitting responses. The job processor 104 receives the submitted responses and collates information from the responses. The job processor 104 provides the collated information as job results to the job provider 102.

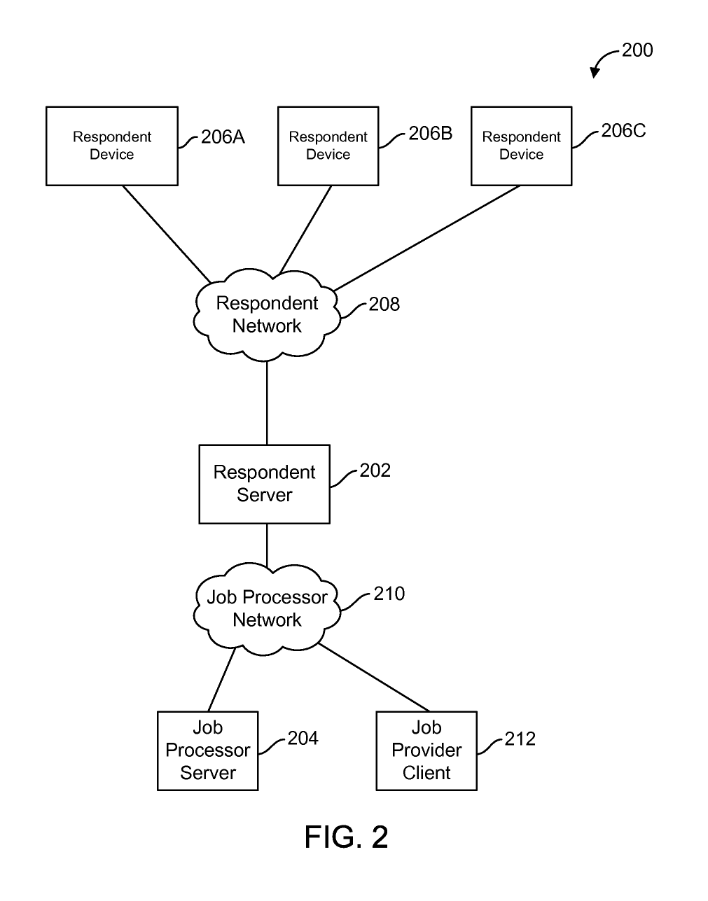

FIG. 2 illustrates a system 200 for managing tasks and respondents 106 in a distributed group of people, in one embodiment. The system 200 includes a job processor server 204, a job provider client 212, a respondent server 202, and respondent devices 206. A job provider 102 interacts with the system through the job provider client 212. The job provider client 212 may be any computing device, such as a workstation or mobile computing device. The job provider may submit jobs, view job status, submit payment, and receive results through the job provider client 212. The job processor server 204 is a computing device that carries out the functions of the job processor 104 described above, including respondent management and task division and assignment. In one embodiment, the job processor server 204 is a server with significant storage and computing capabilities to allow for handling many job providers, respondents, jobs, and tasks.

The respondent devices 206 are computing devices for use by respondents 106 to interact with the system 200. Respondents may use the respondent devices 206 to register with the system, receive tasks, submit responses, and view feedback and rewards, in one embodiment. Respondent devices 206 may be inexpensive mobile devices, such as basic cell phones with text messaging capabilities, which are readily available and widely used in many developing countries. The respondent devices 106 may also include computers in public internet cafes, which the respondents may log into and use from time to time. These are just a few examples, however, and the respondent devices 106 may be any suitable type of device that enables a respondent to communicate with the respondent server 202 to engage in any of the actions described herein in connection with the respondent devices 106.

The respondent server 202 provides an interface for the respondent devices 206 to the job processor server 204. The respondent server 202 may receive registration messages from respondent devices 206 and perform a portion of the processing of the registration messages (e.g., bouncing bad registration requests) before the new respondent is added to the databases of the job processor server 204. The respondent server 202 may receive task assignments in bulk from the job processor server 204 and send the tasks to individual respondent devices 206. The respondent server 202 may similarly receive responses from the respondent devices 206 and send them in bulk to the job processor server 204. In one embodiment, the respondent server 202 handles local communication issues with the respondent devices 206. For example, if a respondent device 206 is a cell phone, the respondent server may communicate via text messages with the cell phone. The job processor server 204 does not need to be aware of the particular communication methods and protocols used between the respondent server 202 and the respondent devices 206.

The job processor server 204, job provider client 212, and respondent server 202 are connected by a job processor network 210. This may be any type of communication network, such as a corporate intranet, a wide area network, or the Internet. The respondent server 202 communicates with the respondent devices 206 through a respondent network 208. This may also be any type of communication network. In one embodiment, the respondent network 208 is a cellular network that supports text messaging, and the respondent devices 206 are cell phones. Although only three respondent devices 206 are shown, there may be many (e.g., hundreds, thousands, or more) in the system 200. Similarly, there may be many respondent servers 202 and job provider clients 212 that communicate with job processor server 204. There may also be multiple job processor servers 204, such as for redundancy or load balancing purposes.

In one embodiment, the respondents 106 may be geographically located remote from the job providers 102. For example, the job provider client 212 and job processor server 204 may be located in a developed country with good network connectivity and the respondent server 202 and respondent devices 206 may be located in a developing country with poor network connectivity. In this case, buffering may be performed between the job processor server and the respondent server in order to decrease latency and data loss. This buffering may be performed by components of the respondent server 202 and job processor server 204, or it may be performed by other computers and additional networks.

In another embodiment, a simplified network configuration may be used, where the respondent devices 206, respondent server 202, job processor server 204, and job provider client 212 are all connected to the same network (e.g., the Internet). This may be used if all the devices have good connectivity to the same network. In one embodiment, the job processor server 204 and respondent server 202 may be the same computer.

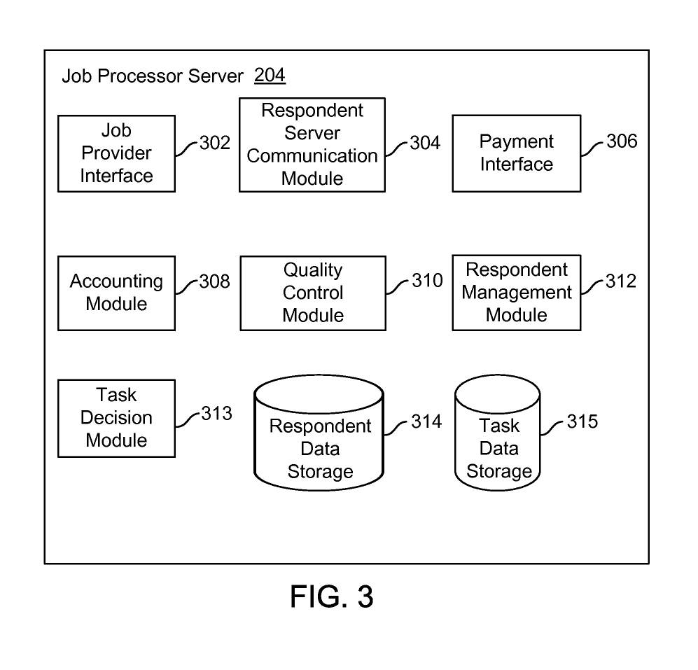

FIG. 3 is a block diagram illustrating the job processor server 204, in one embodiment. The job processor server 204 includes a job provider interface 302, a respondent server communication module 304, a payment interface 306, an accounting module 308, a quality control module 310, a respondent management module 312, a task decision module 313, a respondent data storage 314, and a task data storage 315.

The job provider interface 302 interacts with the job provider client 212. In one embodiment, the job provider interface 302 includes a web server to provide the job provider client 212 with a web-based interface to submit jobs and receive results. The respondent server communication module 304 communicates with the respondent server 202, including sending tasks (possibly in bulk) and receiving responses. The accounting module 308 determines rewards to be given to respondents for their completion of tasks. The payment interface 306 handles payment transactions with the job provider and respondents. The payment interface 306 may interface to various financial payment systems. These processes are described in more detail below.

The quality control module 310 determines the quality of respondent responses and job results. The respondent management module 312 keeps track of respondents, including information about respondents, relationships between respondents, and past performance of respondents. The task decision module 313 divides jobs into tasks and assigns tasks to respondents. The respondent data storage 314 stores information about respondents. This information may be stored by the respondent management module 312 and accessed by the task decision module 313. The task data storage 315 stores information about tasks, such as the tasks needed for a particular job and the status of these tasks (e.g., assigned, completed, etc.). The task data storage 315 may be accessed by the task decision module 313. In one embodiment, the respondent data storage 314 and task data storage 315 are stored on a storage device of the job processor server 204. These processes are also described in more detail below.

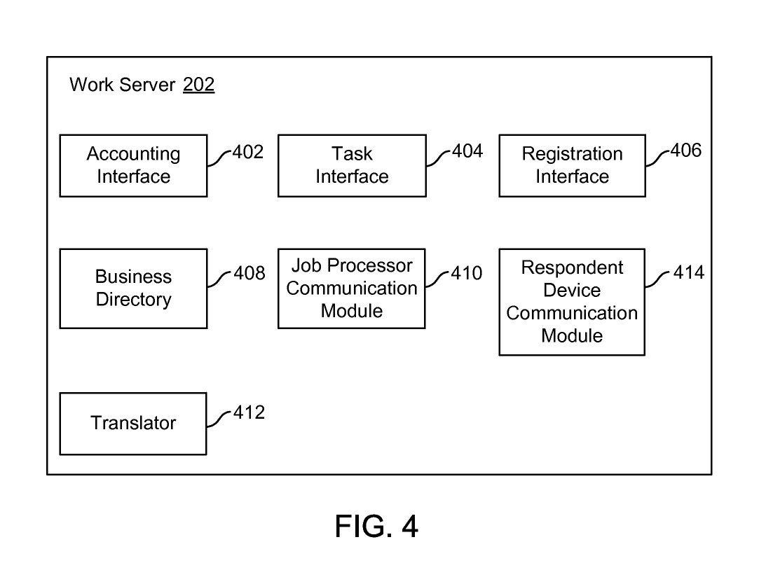

FIG. 4 is a block diagram illustrating the respondent server 202, in one embodiment. The respondent server includes an accounting interface 402, a task interface 404, a registration interface 406, a business directory 408, a job processor communication module 410, a translator 412, and a respondent device communication module 414.

The accounting interface 402 provides an interface to respondent device 206 for rewards. For example, a respondent device can check rewards or be notified of rewards by the accounting interface 402. The task interface 404 notifies respondent devices of tasks, receives task responses, and provides an interface for other task-related issues. The registration interface 406 enables respondents to register through respondent devices, and it receives and processes registration messages. The job processor communication module 410 handles communications with the job processor server 204, which may include buffering of information to be transmitted over the job processor network 210. The respondent device communication module 414 handles communications with the respondent devices 206, which may include buffering of information to be transmitted to the respondent devices 206 over the respondent network 208. For example, the respondent device communication module 414 may convert tasks into text messages and provide them to a Short Message Service (SMS) gateway or an Unstructured Supplementary Services Date (USSD) gateway.

The business directory 408 may include a directory of local businesses that can be used for task generation or assignment as further discussed below. The translator 412 can translate messages into a language understood by respondents. For example, a task may be received from the job processor server 204 in one language, and the task can be translated into another language before being sent to the respondent device 206.

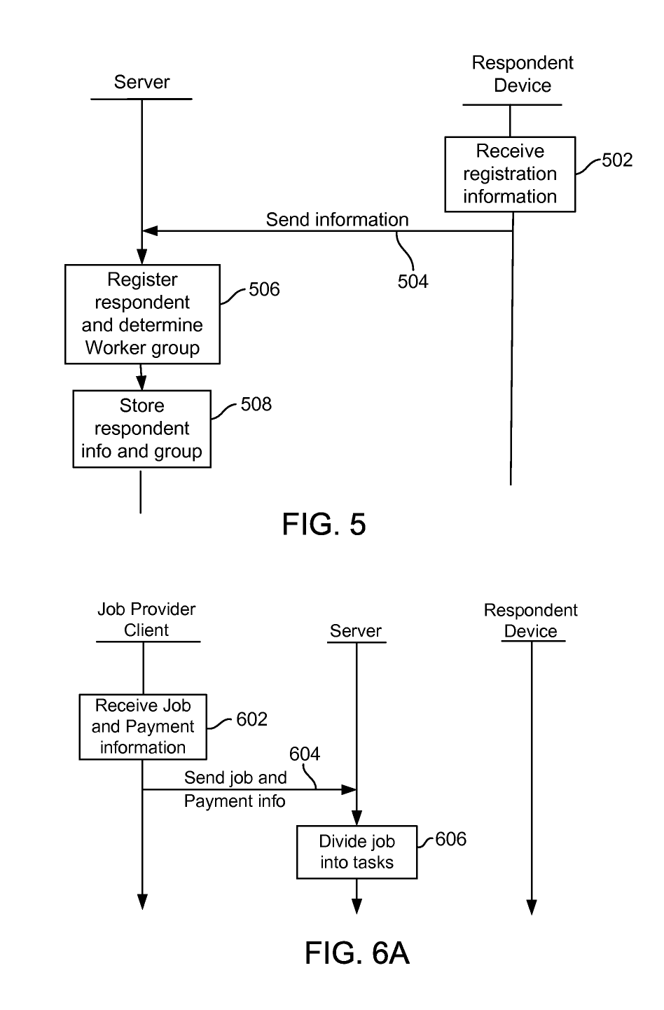

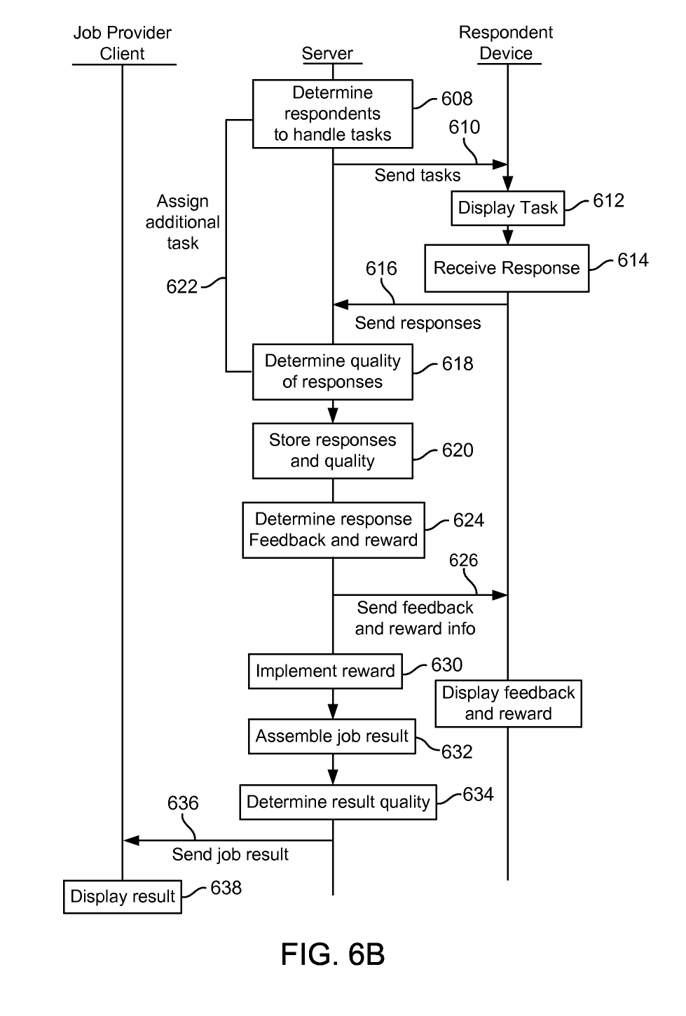

Some of the functionality of the respondent server 202 described above may be included in the job processor server 204, in some embodiments. Similarly, some of the functionality of the job processor server 204 described above may be included in the respondent server. Also, as mentioned above, the job processor server 204 and the respondent server 202 may be the same computer. In the processes illustrated in FIGS. 5-6 and described below, the job processor server 204 and respondent server 202 are combined into a single entity, which is referred to as the “server” for ease of description. In an embodiment with a separate job processor server 204 and respondent server 202, the job processor server 204 and the respondent server 202 communicate with each other to perform the functions of this server.

### Tracking and Managing Respondents

FIG. 5 illustrates one embodiment of a process for registering a respondent 106. As mentioned above, respondents may register with the system so that they can be tracked and assigned appropriate tasks. Initially, registration information is received 502 at a respondent device 206 from the respondent (e.g., input into a user interface of the respondent device 206), and this information is sent 504 to the server. For example, a respondent may enter a text message into his or her respondent device 206 that includes various registration information and then sends the text message to a phone number or SMS code associated with the server. The respondent may have previously been given instructions on what to include in the text message and what number to send it to. In one embodiment, the respondent may input and send data multiple times during registration. For example, the respondent may send a first text message with some information, receive a response from the server, and then send further information in a second text message. In one embodiment, registration information is provided via a web-based form that is displayed on the respondent device.

The information sent to the server from the respondent device 206 may include various types of information about the respondent and other information that may be of relevance in assigning tasks, evaluating responses, or determining rewards. Examples of information include the name of the respondent, the location of the respondent (e.g., city or postal address), age, gender, or other demographic or socio-economic information. Further information may include the respondent's desired types of task (discussed further below), the respondent's desired quantity of task, and the times that the respondent is available to do the task (e.g., time of day, days of week). The information may also include how the respondent desires to be rewarded. For example, the respondent can provide a bank account number for cash rewards to be deposited, or the respondent may provide the details of a wireless services account and indicate that the respondent prefers to be rewarded with value (e.g., as measured in some kind of currency units) added to the balance of that wireless services account. The respondent may also provide information to set up secure future interaction with the system, such as various login questions and answers or a password. Additionally, if the respondent device is a cell phone, the server will receive the cell phone number. This number may be used by the server to uniquely identify the respondent in the future.

In one embodiment, a respondent 106 can register other respondents or otherwise indicate a connection to one or more other respondents. A respondent may serve as a manager of other respondents and be responsible in various ways for those respondents. In many cases, a manager will personally know his or her subordinates and be able to supervise them outside of the system 200 through personal interaction. For example, a manager may be an adult that is responsible for a group of poor or at-risk teenagers. The manager may register all of his subordinate respondents and specify himself as their manager. In other embodiments, the manager-subordinate relationship may be more informal or unstructured. For example, although the manager may not be officially his subordinates' manager, the manager may have incentive to encourage his subordinates to perform their individual tasks in a manner that achieves a group objective or promotes a desired group behavior. The manager may then be rewarded if his subordinates (formal or informal) subsequently perform well on tasks and penalized if they do not, as further described below. He may also have the power to enable or disable their working privileges at any time. For example, if one of his subordinate respondents engages in undesirable behavior, such as skipping school or using illegal drugs, the manager can temporarily halt his working privileges and prevent him from completing tasks or receiving rewards for a certain period of time. In one embodiment, a respondent may also indicate respondents that he or she knows, even if the relationship is not a managerial one.

Information about personal relationships that are provided to the system 200 may be useful for task assignments and reward determinations. Since a manager may be rewarded or penalized based on the performance of subordinates, the manager may exert influence on subordinates to perform well and provide them with additional motivation. Also, the manager may be able to provide more details about the subordinates' skills and abilities to the system 200 to enable better assignment of tasks to the subordinates. Managers may also be motivated to recruit new respondents to perform tasks for the system 200. Information about non-managerial relationships may also be useful in task assignments, as some tasks may be designed to be worked on cooperatively by a group of respondents offline. In such a cooperative task, the rewards of all the involved respondents may depend on the quality of completion of the task, resulting in peer pressure among members of the group to perform well.

Returning to FIG. 5, the server registers 506 respondents and may also determine respondent groups. In one embodiment, registration involves storing registration information associated with a respondent in the respondent data storage 314. The respondent data storage 314 may be a database in which each row corresponds to a respondent having a unique identifier (e.g., cell phone number) and the columns correspond to types of information about the respondent.

Respondent groups to which the respondent belongs may also be stored in the respondent data storage. One type of group is a group formed by the associations discussed above. For example, a manager respondent and associated subordinate respondents may be considered a group. Another type of group is a group that is formed based on commonalities in registration information. For example, respondents living in the same city may be placed in a particular group even though they do not indicate knowing each other during registration. Respondents of similar ages, respondents having similar skills, and respondents having other similar traits may be placed into groups. Groups may be useful for task assignment purposes as described further below.

In step 508, the server 204 stores respondent information and group information in the respondent data storage 314, e.g., in a respondent profile for each respondent. The server may then send a confirmation of registration to the respondent device, which displays the confirmation to the respondent. Once a respondent has been registered, the respondent is eligible to receive and perform tasks, and be rewarded for doing so, as described below.

### Performance of a Job by a Distributed Group of People

FIGS. 6A and 6B illustrate a process for managing the performance of a job by a distributed group of people, in one embodiment. A job is received 602 from a job provider via a job provider client 212. For example, the job provider may enter job information into a form on a web browser running on the job provider client 212. The job provider may have previously registered with the system 200 and set up an account with the job processor server 204.

Payment information may also be received 602 from the job provider. The payment information may include an amount specifying how much the job provider is willing to pay. Moreover, the job provider may select from a number of options regarding the cost of the job versus a degree of accuracy of the result (where a higher level of accuracy of the result costs more, because it more likely involves more tasks sent to individual respondents, and thus more cost to the job processor). The payment information may also include a method of payment, such as a credit card number, bank account, or other source of funds. Different payments may be specified for different levels of completion of the job or different qualities of results. The job information and payment information is sent 604 to the server.

The job may be any of a wide variety of jobs that may be broken down into several tasks to be performed by the distributed group of people. One example of a job is to translate a book from one language into another. For such a job, the job provider may send the text of the book along with an indication of the desired translation language to the job processor server. Another type of job is image tagging and/or classification. For example, the job provider may have thousands of images taken from a vehicle while driving down a road, where an image is taken every few seconds along the road. The job provider may desire to have each image tagged to indicate whether the image includes a street sign as well as the contents of the sign. Another type of job is entry of data from scanned data entry forms. For example, the job provider may have many scanned forms, where the forms each have several fields containing handwritten information that must be added to a database.

Jobs may also include the classification of various types of documents. For example, a job may be to determine whether various emails from customers are “angry” or not. Based on results provided by the job processor server, the job provider may then take a closer look at these emails to determine what actions might be taken to placate the angry customers. The results of jobs need not be limited to binary classifications. For example, a job may request that various degrees of anger be identified in emails. Alternatively, the job may request a short sentence describing each email. Other types of jobs may involve obtaining classifications, descriptions, or transcriptions of various media items, including images, videos, and audio recordings.

A job may also have multiple stages. For example, a job provider may provide various scanned filled-in paper forms to the job processor server 204 and request that the job processor server digitize the forms and the filled-in values. The job processor server 204 may initially determine the form fields and set up a database having those fields. The job processor server 204 may then create the database records having those fields with the filled-in values.

In addition to processing information provided by the job provider, jobs may involve obtaining new information. For example, a job may be to assemble a directory of businesses in a particular city that includes business names, descriptions, addresses, and photos. The job provider may merely specify the city to the job processor server 204 and rely on the job processor (using the distributed group of people) to obtain the desired business information for the city.

Division of a Job into Discrete Tasks

In step 606, the job is divided into tasks. Task division may be performed by task decision module 313. Jobs may be divided into tasks in a variety of ways. In one embodiment, jobs are divided into tasks that are independent of each other and that can be performed by separate respondents. Various factors may be taken into account when dividing jobs into tasks, including the size or difficulty of individual tasks, the ability to verify task responses, and the ability to assemble responses into a job result.

In one embodiment, the task decision module 313 divides a job into tasks belonging to various levels in a hierarchy such that the tasks of one level need to be performed before the tasks of another level. Dividing a job into tasks within hierarchical levels enables many embodiments, such as providing structure to enable multiple respondents to work on the same job, enabling quality control of the tasks performed by the respondents, efficiently using the available resources, and enabling data security.

Dividing a Job into Tasks within Hierarchical Levels to Provide Structure

For certain jobs, a group of respondents may simultaneously work on various tasks in a job, wherein a respondent first defines a framework or structure for the tasks within the job. For these jobs, the task decisions module 313 divides a job into two levels of task. The first level includes a respondent defining the tasks' structure, and the second level includes respondents performing the tasks. Following are examples of jobs amenable to hierarchical division in various embodiments of the invention.

In one embodiment, a job includes numerous forms that have been manually filled out and, where the fields in the forms need to be converted into digital data. To achieve this goal, the task decision module 313 divides this job into tasks at two levels. The task in the first level involves identifying underlying structure and location of various fields that are common in all the forms. For example, a respondent may identify that the field for “First Name” is located in the left most column of the second row in the form. A respondent enters this identified information on a respondent device 206, and the respondent device 206 transmits this information to the task decision module 313. The task decision module 313 then uses the received information to extract images of manually entered data in the form and associates those images with particular fields in the form. The task decision module 313 then transmits the images to devices 206 associated with respondents that perform the second level task. The second level respondents receive the images of manually entered data and input the electronic data corresponding to the manually entered data. The task decision module 313 receives the electronic data and associates the data with fields in the form associated with the image corresponding to the electronic data. In this manner, the task decision module 313 divides the job of digitizing data such that the digitized data is provided by numerous respondents in a uniform manner, enabling efficient and accurate processing of the digitized data.

In another embodiment, the task decision module 313 divides the job of entering web-based data into a database into a hierarchy of tasks belonging to two levels. The task at the first level requires a respondent to identify through a respondent device 206 parts of various web pages that include particular type of data. The respondent device 206 transmits these identified locations to task decision module 313, and respondents or automated modules can then perform the next level task of parsing data from identified locations into a database.

For an audio transcription job, in another embodiment, the task decision module 313 creates a first level task requiring identification of people speaking during various time intervals. After receiving the speakers' identifications and corresponding time intervals, the task decision module 313 divides the audio file using known audio processing techniques. The module 313 divides the audio file into various parts such that each part includes speech of one speaker. The task decision module 313 then creates second level tasks that required various respondents to transcribe a part that includes a particular speaker's voice.

Like processing of an audio file, the task decision module 313 may divide the processing of an image file or a video file into tasks belonging to one of two levels. For example, the first level task may require a respondent to identify parts of an image or a video that includes a particular object, like a human face. For video, the first level task may require identification of a particular location within a scene that includes the object of interest or identification of duration of video that includes the object of interest. The task decision module 313 receives the identified parts from the respondent device 206 of the respondent that performed the first level task, extracts the identified parts using known video processing techniques, and transmits the identified parts to respondent devices 206 of respondents responsible for the second level task. In one embodiment, the task decision module 313 removes or hides the other parts of the video or the image that are not required to perform the second level task. The second level task may include further processing of the identified object. For example, the task may require a respondent to identify the face displayed in the received part. Such division of tasks can greatly reduce the error rate as a respondent is focused on limited part of the video or image.

Dividing a Job into Tasks within Hierarchical Levels to Enable Quality Control

In other embodiments, the task decision module 313 divides a job to achieve quality control. For example, the task decision module 313 divides a job such that a first level of respondents complete the job and a second level of respondents review the results of completed jobs. The task decision module 313 employs such a division for jobs that involve subjective data creation. For example, a job requiring short essays may be divided into a first level of tasks of writing these short essays. After the respondents at first level complete their assigned essays and transmit the completed essays to task decision module 313 through their respondent devices 206, the task decision module 313 transmits the received essays to devices 206 of second level respondents that review these essays. The task decision module 313 limits the probable responses from the second level respondents. For example, the evaluation responses may be limited to “approve” or “reject,” or they may be limited to a one of the five scores ranging from number one to number five.

This division of respondents in data producer and data reviewer roles enables quality control of jobs requiring subjective data creation. Although two reviewers may not provide the same evaluation for produced data, the evaluations of various tasks from the same reviewer would indicate the respondents that a particular reviewer judges as a good producer. If a respondent is judged by various reviewers as a good producer, such respondent is likely to be a better producer than respondents judged as worse producers by various judges. Eventually, the task decision module 313 also starts assigning reviewing tasks to consistently good producer. Accordingly, the task decision module 313 also improves the quality of the final output by promoting good producers to reviewers.

The task decision module 313 may apply the above described division of job between data producers and reviewers to various jobs that require respondents to create subjective data. For example, jobs involving translation from one language to another may lead to various resulting translations that are not literally identical but convey the same substance. These translation jobs can be divided into resulting translation producing tasks that are then reviewed for quality control. Other jobs may also lead to varying data creation that can be then reviewed for quality control. Examples of such jobs include creating drawings, taking photographs, performing internet searches, and taking surveys that require essay-type responses.

The task decision module 313 may apply similar division techniques to a customer support job or a software quality assurance job. The data creation tasks for these jobs include providing help to a customer via phone or computer and describing flaws in given software. Multiple reviewers may be assigned to review the task completed by a respondent. Such review by multiple reviewers enables evaluation of the respondent's performance. Additionally, part of the reviewer's feedback or evaluation can also be added to the respondent's results. For example, the reviewers may provide a better definition of the problem and this definition may be added to the description provided by the respondent. Moreover, the reviewers' reviews can be reviewed by reviewers at another layer. This review enables quality control of the reviewers themselves.

For jobs requiring specialized training, the task decision module 313 selects respondents and reviewers that have the required training. For example, the task decision module 313 selects respondents with the required training for jobs requiring legal, tax, medical, investment, accounting, agricultural, and future forecasting advice.

In other embodiments, the task decision module 313 divides a job into hierarchical tasks that lead to more consistent results regardless of different respondents completing similar tasks. For example, the task creation module 313 creates or retrieves a set of hierarchical questions for a job. Each determined question has a limited set of answers. Moreover, the sequence of questions is set such that the sequence varies based on an answer for a preceding question. By answering this sequence of questions, each respondent ends up with one of the predetermined answers, or results, for the job. Accordingly, although different respondents perform similar jobs, these jobs are divided into hierarchical questions that lead to one of the pre-determined answers. The respondents' answers are therefore limited to a set of answers and this limited set provides consistency between the respondent's answers to similar jobs.

Image tagging is an example of such a job that can be divided into tasks that include hierarchical questions. An image may be associated with numerous tags, and different respondents may create different tags for an image if the respondents were allowed to create a tag. Instead, the task decision module 313 creates or retrieves questions similar to the above described sequence of questions. This sequence guides the respondents to choose from a limited set of tags instead of creating their own tag. For example, the first question may inquire whether the image includes a person, an animal, or an object. If animal is selected, the next question may inquire whether the animal belongs to a particular family like feline family, dog family or another family. Based on the selected answer, the next question may inquire about the animal's breed and the answer choices may present various breeds in the selected family. Such questions may go on until a specific enough answer is selected. In this manner, the task decision module 313 uses a hierarchy of questions to guide the respondents to choose from a limited set of answers.

In one embodiment, the task decision module 313 transmits, to numerous respondents, a hierarchy of questions for the same job. Each respondent answers the hierarchy of questions and eventually chooses a specific answer at the end of the question sequence. The answers from the various respondents are then compared to determine the correct answer (i.e. the answer chosen by majority of respondents). In this manner, the sequence enables the task decision module 313 to determine the accuracy of answers provided by various respondents.

In sum, the task decision module 313 provides quality assurance for a job by dividing the job into tasks of various hierarchical levels. Such a division beneficially enables reviewing a respondent's output or receiving more consistent results using above described sequence of questions. Because the respondents' performance can be reviewed, the quality assurance also leads to identification of better respondents that can be rewarded for their work. The job processor server 204 may use the reviewer's feedback, discussed above, to determine the underperforming and excelling respondents. The identification of the respondents is transmitted to the accounting module 308, which may determine higher compensation or promotion for excelling respondents and lower compensation or demotion for underperforming respondents.

Dividing a Job into Tasks within Hierarchical Levels to Promote Efficiency

The task decision module 313 may divide a job into various tasks to efficiently use the available respondents and/or to improve the efficiency of an individual respondent. For example, the task decision module 313 may assign an individual respondent to a number of related tasks so the respondent can apply the knowledge gained from a previous task to a later task. In one embodiment, the task decision module 313 creates a preliminary task for a first level respondent to determine related tasks for a second level respondent. After the first level respondent has identified the related tasks, the task decision module 313 receives the identified tasks and transmits them to the second level respondent's device. Because the second level respondent receives a set of related tasks, the respondent may build knowledge from initial tasks to complete later tasks more efficiently.

In one embodiment, the task decision module 313 divides a job into various tasks to provide a framework or a set of instructions for the respondent. The above described question sequence is an example of such a framework. The framework enables a respondent to work more efficiently as the respondent need not spend time and energy determining a plan of attack for the task.

Additionally, in one embodiment, the task decision module 313 divides a job for a single respondent into various tasks that are performed by a computer and then reviewed by the respondent. For example, an initial task may require a computer to identify a particular object in various parts of the image. The next task may require the respondent to review the computer identified parts and select the parts that have been correctly identified by the computer.

In this manner, the task decision module 313 increases a respondent's efficiency by dividing a job into a set of related tasks, a sequence of questions, or by dividing a task between a respondent and a computer. Additionally, the task decision module 313 divides a job into tasks to improve the collective efficiency of a group of respondents as described below.

In one embodiment, the task decision module 313 divides a job into tasks that require a particular expertise and other tasks that do not require any particular expertise. This division enables efficient use of expert's time because the expert need only work on tasks requiring expertise and the remaining tasks can be completed by other respondents or computers. For example, the task decision module 313 divides into tasks a job of converting manually filled insurance forms into digital data. The first level task requires an insurance expert to identify each field in the form, determine the meaning of those fields based on her expertise, and create instructions for second level task of converting the forms' manual data into digital data. The task decision module 313 receives these instructions and transmits these instructions to devices of second level respondents. The second level conversion task can be further divided to efficiently use the respondents' time. For example, the initial task of converting manual data to digital data can be assigned to an OCR module. The respondents can then verify the OCR module's output and correct the OCR module's errors through their respondent devices 206.

Similarly, for specialized transcription and translation jobs, like medical transcription or translation of medical documents, the task decision module 313 may divide the job into tasks that require specialized vocabulary and other tasks that do not. The task decision module 313 can then assign the tasks requiring specialized vocabulary to the expert and the remaining tasks to other respondents or computers. In one embodiment, the task decision module 313 creates a first level task that requires a respondent to identify parts of an audio file or a document that includes words or phrases likely to be understood by an expert instead of a lay person. The respondent may simultaneously transcribe or translate parts that do not require the specialized vocabulary. The task decision module 313 then assigns the identified parts to an expert, and the expert transcribes or translates the identified part.

In another example, for an electronic discovery job (i.e., searching electronic documents for information related to a particular legal issue), the task decision module 313 divides the job into a first level task that includes the tasks of weeding out clearly unrelated documents. The second level task requires an expert to review the remaining documents to identify documents that include relevant information. Because the clearly unrelated documents were weeded out at the first level, the expert's time is more efficiently used to review a smaller body of documents.

The task decision module 313 may also divide, in a similar manner, the image segmentation jobs, which are jobs that require identification or analysis of various parts of an image. Examples of these jobs include facial identification, highlighting issues in medical scans, and satellite imagery analysis. The task decision module 313 divides these jobs into a first level of tasks that to be assigned to a less skilled respondent and a second level of tasks to be assigned to experts or computers. The first level tasks includes tasks like identifying parts of image that require expert skills, parts of image that are or are not relevant, and adding metadata to parts of the image that is later used by other respondents or computers. The second level tasks include tasks requiring a certain expertise or a task that can be efficiently performed by a computer. If the task is assigned to a computer, the task decision module 313, in one embodiment, creates a third level of tasks requiring respondents to verify the computer's output.

Similarly, the task decision module 313 may divide exception management jobs into first level of tasks to be completed by unskilled respondents or computers and subsequent level of tasks to be completed by more skilled respondents. For example, a job identifying license plate numbers in a collection of images is divided into two levels of tasks. The first level task is assigned to a computer, and the task involves identifying license plate numbers in the images. The task decision module 313 creates a second level of tasks that involves various respondents verifying the computer's output from the first level task. In one embodiment, the task decision module 313 further creates a third level of tasks that requires supervisors to verify a portion of the results provided by respondents executing the second level tasks. In this manner, the respondents are efficiently used because verifying identified numbers is faster than identifying and inputting numbers. Additionally, the supervisors are efficiently used because the tasks assigned to supervisors are fewer in numbers and therefore require lesser time from the supervisors.

In addition to dividing a job into tasks based on respondents' skill, the task decision module 313 may divide a job into tasks based on various resources available to different respondents. For example, the task decision module 313 divides a job into tasks that require a particular software program and tasks that do not. The tasks requiring a particular program are assigned to respondents whose respondent devices 206 have the required program. The remaining tasks are assigned to other respondents. Information about various programs supported by a particular respondent's device 206 is collected by registration interface 406 during the respondent's registration. This information can later be accessed by the task decision module 313 to determine how to divide a job into tasks based on resources available to a particular respondent. In case a respondent updates his device 206, the respondent can update the device's capabilities through registration interface 406. Consequently, the task decision module 313 may assign additional tasks to the respondent based on the updated capabilities of the respondent's device 206.

For the above mentioned jobs, the task decision module 313 may create a task of judging a respondent's ability or expertise. The task decision module 313 assigns this job to respondents in manager roles. The task requires these managers to evaluate the output provided by the respondents and provide feedback indicating an objective evaluation of the respondents. For example, the task may require the manager to assign a score in various categories for the respondents. These scores can be used to determine a respondent's expertise and the determined expertise is used by the task decision module 313 to assign various tasks to the respondents. Because the tasks are assigned to respondents based on their determined expertise, instead of randomly, the respondents are likely to complete the assigned tasks more efficiently.

In one embodiment, the manager's skill in evaluating other respondents can also be evaluated based on the respondents' productivity. The task decision module 313, in this embodiment, assigns randomly chosen respondents to various managers. Based on the manager's evaluation, respondents' expertise is determined, and the respondents are assigned various tasks based on their determined expertise. Eventually, the respondent's output is evaluated and based on the respondent's output, a respondent's productivity is determined. A higher productivity serves as a proxy for better evaluation by a particular manager.

In this manner, the task decision module 313 divides a job into various tasks to enable quality control and promote efficiency. Additionally, the task decision module 313 divides a job including confidential information into tasks such that all respondents executing the tasks do not have access to the confidential information. Embodiments for dividing such jobs into tasks are further described in U.S. provisional patent application No. 61/474,274 (“'274 application), titled “Completing tasks involving confidential information by distributed people in an unsecure environment,” which is incorporated by reference in its entirety. In the '274 application, the job processor server 204 identifies confidential data associated with the job. The job processor server 204 then manipulates the confidential data before transmitting the data to respondents' device 206 for further processing. In one embodiment, the task decision module 313 divides such jobs into tasks for two levels of respondents. The first level of respondents includes trusted respondents that are authorized to handle confidential information. The task decision module 313 transmits the job with confidential data to these respondents. These respondents, instead of the job processor server 204, identify and manipulate the confidential data to obscure the confidential information in the data.

Accordingly, these respondents perform confidential data identification and manipulation part of techniques, like filtering, described in the '274 application. The respondents then transmit the manipulated data from their devices 206 to the task decision module 313. The task decision module 313 then divides the job with manipulated data into tasks for second level of respondents. In this manner, the task decision module 313 divides the job with confidential data such that the second level respondents are not privy to confidential information associated with the job. For example, a first level respondent is assigned to identify and distort confidential information like social security numbers in medical forms. The respondent distorts the information manually or through a software application. After distorting the confidential information, the respondent transmits an image of the document with distorted data to the task decision module 313. The task decision module 313 receives such images and transmits these images to second level respondents for further processing.

### Assignment of Respondents to Perform the Tasks

The server then determines 608 respondents to handle the tasks. The task decision module 313 may communicate with the respondent management module 312 to retrieve information about possible respondents from the respondent data storage 314. Task assignment decisions may be based on many factors, including data provided about respondents during registration (or subsequent update of registration information), and including data learned about respondents from their past performance of tasks. In the example discussed above about translating text from a first language to a second language, respondents can be chosen who are known to understand both the first language and the second language. This can be determined from their registration information (e.g., language skills indicated while registering). It can also be determined from their past performance of tasks, such as whether they have been able to successfully complete tasks in the past in both of those languages. The translation skill of potential respondents can be determined from the respondents' performances on past translation tasks.

As described further below, when a respondent completes a task, the quality of completion may be determined and stored. The information regarding the quality of a respondent's performance on previous tasks maybe used to assign subsequent tasks. Various attributes of respondents may be learned based on their past performance, including: overall response quality, response quality for different sorts of tasks, quality of responses for tasks requiring particular knowledge or skills, response time, and dependability (e.g., likelihood of receiving a response). Models can be constructed of respondents based on this information to predict their likely future performance on various tasks, and these models may be used to assign subsequent tasks. In one embodiment, a machine learning model is trained using many respondents' attributes and their performance on tasks, and this trained model is then used to predict a respondent's performance on future tasks. These predictions may be used to determine which respondents to assign which tasks, as discussed herein.

Tasks may also be assigned based on respondent groups 108. Respondents in a particular group may share a common characteristic or otherwise have a relationship among the group members, as mentioned above. If a task requires respondents having a particular characteristic (e.g., a skill in a particular language, or a location in a particular city), then the population of respondents eligible for the task may be limited to an appropriate respondent group. Respondent groups may be used to assign tasks to respondents who personally know each other, if such an assignment is necessary or is likely to provide increased motivation to the respondents to perform the task well. Conversely, respondent groups may be used to assign tasks to respondents who are unlikely to know each other personally (e.g., who live in different cities) if a lack of connection among the respondents for a given job is desirable for security or verification purposes.

In one embodiment, the job processor server 204 does not have knowledge of the current status of specific respondents when assigning tasks. For example, the job processor server 204 may not know which respondents are currently online and available to receive tasks. In this case, the job processor may determine the required characteristics of potential respondents (e.g., particular respondent groups needed). This information may then be sent to the respondent server 202, which can then choose individual respondents for task assignments. In another embodiment, respondents send messages to the respondent server 202 indicating when they are available to receive new tasks. For example, a respondent may indicate that he or she is willing to receive tasks during the next six hours, or some other time period. In this embodiment, the job processor server 204 may assign tasks to respondents based in part on the respondents' stated availability to perform the tasks.

The tasks are sent 610 to the respondent devices and displayed 612 to the respondents. Tasks may include instructions for performing the task and possibly data for processing, such as text, images, audio, or video. The respondents then perform the tasks. Task performance may involve manipulating or processing the information provided in the task or may involve the respondent obtaining information from outside sources and/or performing some other type of work. Upon completion of the task, a response is received 614 by the respondent device 206 from the respondent. For example, the respondent may enter a text response into his or her cell phone. The task response is then sent 616 to the server.

The server then determines 618 the quality of responses received. As mentioned above, this can be performed through the use of verification tasks. In one embodiment, a specially trained and trusted pool of people may verify a certain fraction of responses (or all responses). Response quality may also be determined through various other methods, such as automated algorithms that can detect clearly incorrect responses (e.g., where a 50-word paragraph is translated into a single word of another language). The received responses and the quality measures determined for the responses are stored 620. In one embodiment, additional tasks may be assigned 622 after some responses are received. If any task responses are determined to be of low quality, the same tasks can be re-assigned to other respondents.

If the server is unsure of the quality of a response, the same task can be sent out to multiple respondents to determine the correct or best response. For example, the server may look at subsequent responses to confirm a previous response. If the responses from multiple respondents differ, the correct or best response may be determined according to the frequency of each response and/or the reliability of the respondents providing the responses, among a number of other factors. If task responses of acceptable quality are received, tasks corresponding to the next stage of the job can be assigned and sent to respondent devices 206 (in the example above, translation tasks can be sent out after receiving quality responses to OCR tasks).

### Rewarding Respondents for Completing Tasks

Response feedback and rewards are then determined 624 for the responses received. The feedback for a given respondent's response may indicate the quality of that response. The feedback is useful because it communicates to the respondent how well the task was performed, which enables the respondent to improve performance for future tasks and incentivizes the respondent to do so. The feedback may be expressed as a binary (e.g., good or bad) or numerical (e.g., “5 out of 5 stars”) value, and it may include written indications of quality or other relevant notes (e.g., “75% of verifiers disagreed with your response” or “You did not respond within the requested three-hour period”). The feedback may also include suggestions for improving the respondent's future responses (e.g., “Please provide a shorter response in the future”). Feedback may be provided for individual responses from the respondent, or it may be provided to the respondent in the aggregate for multiple responses. In a hierarchical arrangement of respondents, the feedback may be provided to the respondent and to any of the respondent's supervisors.

Rewards may be determined based on a variety of factors, including the quality of the respondents' responses and the difficulty of the tasks. The server may determine the quality of the responses using various techniques, as discussed above, including by assigning verification tasks to other respondents. Moreover, the difficulty of a task may be determined in many ways, such as by receiving an indication of the difficulty from the job provider or the job processor, or by requesting the opinion of other respondents about the difficulty of the task. For example, one type of respondent task may be to rate the difficulty of other tasks, such that one respondent's response to a task is used to determine the compensation for another respondent's response to a different task.

In one embodiment, respondents are compensated based on an expected value of their responses to the system. For example, a system may assign the same task to several respondents until a threshold confidence level is reached for the task, at which time the system determines the correct response for the task within an acceptable margin of error. In such an embodiment, the system may keep track of each respondent's reputation to predict how often the respondent is expected to provide a correct response. A respondent's reputation may be based on the historical accuracy of the respondent's responses. For more accurate respondents, the system would expect to need to assign the same task to fewer respondents to achieve the necessary confidence level for the task. This is in part because less accurate respondents need more confirming responses before the system can reach the necessary confidence level for a response. Since the system pays respondents for their responses to tasks, fewer assigned tasks results in a lower cost to the system. Accordingly, the expected value of a response from a more accurate respondent is higher than the expected value of a response from a less accurate respondent, regardless of the content of the responses. The system may thus compensate respondents differently based on the accuracy of their responses to previous tasks, and this compensation need not take into account the accuracy of the response for which a respondent is presently being compensated.

More generally, respondents may be compensated for their responses during one period based on their performance during one or more previous periods. This way, respondents will earn a known, stable pay for their work for a given period, but they are also motivated to perform well. With a higher performance during one period, a respondent can effectively earn a raise for the subsequent period. But with a poor performance, the respondent may earn much less in the next period. In such a scenario, the respondent with poor performance may be motivated to quit, which would be a small loss to the system. Alternatively, a respondent with poor performance could attempt to improve that respondent's reputation with a good performance, and thus earn a higher compensation. Beneficially, this provides a path for a respondent to rehabilitate the reputation while requiring less investment, since the respondent is earning less during this time.

In one embodiment, respondents are compensated only if their responses are correct, or at least verified. For example, a response may be verified by other respondents' responses, after which the respondent may be compensated for the verified response. The verification process also provides opportunities to motivate respondents using compensation. For example, a respondent may be assigned a task that comprises verifying another respondent's response, and the respondent may be compensated for identifying an error in the other response and/or for improving or adding to the response being verified. In addition, a respondent whose previous response was declared to be incorrect (e.g., based on other respondents' responses to a verification task) may be given the opportunity to post a bounty from the respondent's own account to “re-grade” the response. If the response is then verified, the respondent keeps the posted bounty and also receives additional compensation; otherwise, the respondent loses the bounty, which is used by the system to offset the costs of reevaluating the response.

Variable rewards and other types of reward distributions may be used to motivate respondents to provide high-quality responses. Among various compensation schemes, the respondents may be compensated additionally by improving their quality, accuracy, and/or response time. For example, a respondent may receive a bonus compensation for providing a certain number of consecutive correct answers, for achieving a certain accuracy percentage over a period of time or series of tasks, or for providing a certain output of responses during a given period. Respondents may also be paid for responding to surveys or questionnaires. Further, respondents may be compensated for performing tasks in the real world, which may or may not relate to an assigned task from the job processor. Such tasks may include interviewing someone, recording answers, participating in a “secret shopper” program, rating a consumer experience (e.g., confirming that an item is purchasable), going to a location and gathering or verifying Point of Interest (POI) data, delivering a package for someone (e.g., to help to solve the last mile delivery problem), or any of a variety of actions that can be performed in the real world.

Rewards may also be given to managers for tasks performed by subordinate respondents. Good performance by subordinates may result in a bonus being given to the manager, while poor performance by subordinates may result in reduced rewards being given to the manager. This encourages the manager to motivate his or her subordinates to perform more tasks and to perform them well. The compensation in a hierarchical system may also be based on the respondent's title. This additional compensation reflects the additional responsibility that accompanies a managerial role, and it encourages other respondents to strive for a promotion through good performance of their tasks. Rewards may also be given to an entire group of respondents if the respondents as a whole perform tasks well. This also encourages members of a group to motivate others in the group to perform well.

Various forms of rewards may be used, including cash payments, credits to various stores, or redeemable coupons. In one embodiment, the reward is a direct payment to a debit card or bank account associated with the respondent. If the system does not have access to a bank account for the respondent, the system may set up a bank account for the respondent at a bank that is local to the respondent, fund the account, and give information to the respondent necessary to access the account. In another embodiment, the reward comprises an addition of value (e.g., measured in some form of currency) to the wireless services account associated with the respondent and/or associated with the respondent's cell phone (which may also serve as a respondent device 206). This may be particularly attractive for respondents on prepaid cell phone plans. In some markets, currency stored in the balance of a wireless services account can be redeemed as real cash (at some local transaction cost) or sent to another person's wireless services account, as a gift or as a payment in exchange for goods, services, etc.

In another embodiment, the reward provided to the respondents comprises a PIN-based “gift certificate,” which may or may not be associated with a physical gift card. Accordingly, the PIN associated with the gift certificate can be freed from the card and sent directly to a respondent's mobile phone or other computing device. The respondent can then redeem the certificate locally. In addition to being redeemable at retail stores or restaurants, the gift certificates may be associated with costs of living, such as electricity bills or rent, or broadly with anything that a respondent may need to pay for.

The reward may include a variety of other types of economic benefits for the respondent. For example, the reward may include a fee reduction or partial payment of costs on behalf of the respondent (e.g., tuition for school, trade programs, or other training to benefit the respondent). The reward may also include payment in the form of virtual currency, which may enable online purchases of games, music, movies, or any other computing resource that may be purchased using virtual currency. In one embodiment, the value of the reward (regardless of its form) is randomized. In such an embodiment, the value of the reward may be set randomly, similar to a lottery ticket, where the value has a chance of being relatively large. The random-value reward may also be set with a nonzero minimum to guarantee that the respondent earns at least some value. Alternatively, the reward may simply comprise one or more entries to a raffle, where more entries provide the respondent with a greater chance to win the prize. In another embodiment, the reward may include a payment to a charity, possibly chosen by the respondent, either anonymously or on behalf of the respondent.

The reward may include non-economic benefits for the respondent. In one embodiment, respondents who have performed well may be “promoted” in various ways, and notice of this promotion can be sent to the respondent along with the feedback. The reward may also include providing the respondent with symbols of the increased status, such as by “badges” that may be displayed via the respondent user interface portal and visible to the respondent's associates and/or friends. In this way, respondents may be motivated to perform well so as to achieve levels of status within their social circles.

After performing certain tasks well, a respondent may become qualified to verify or otherwise monitor the performance of other respondents on various types of tasks. A respondent may also be promoted to a supervisory role and assigned subordinate respondents, and a new respondent group may be created similar. As discussed above, the compensation scheme may allow a respondent who has a managerial role to receive increased rewards for the work of respondents under that manager respondent. Through promotion, a respondent may become qualified to take on different kinds of tasks (e.g., more difficult and more important tasks, which may lead to higher payments).

Even in the absence of a specific promotion to a different respondent role, a respondent may be rewarded with a certification. A certification may indicate that the respondent is specially qualified to perform certain tasks (such as translation tasks). Defining different fields of certification may provide the system with a better mechanism to evaluate a respondent's responses and to compensate the respondent for them. For example, a respondent who is certified only in translation may have better opportunities for tasks that relate to translation, but not tasks that relate to image recognition. Also, respondents who have been certified for a particular skill may be made directly available to potential employers in a real world marketplace setting, rather than in a strictly managed environment of the distributed group of people discussed herein.

Other non-economic rewards may include access to information, the Internet, or generally to computing resources. For example, the respondent may be compensated by providing the respondent with access to sports information, weather information, information on how friends did with similar work, training information related to how to do tasks more efficiently or profitably, or any other type of information that is relevant to a particular respondent. The information may be provided in various ways, including over the same network used to send the tasks. Rather than specific information, the compensation may comprise providing the respondent with Internet access, such as through mobile phone providers, ISPs, or cyber cafes (which is beneficial where the respondent does not own his or her own hardware). For example, a respondent may need to do a small amount of work before he or she can check e-mail.

In another embodiment, the respondent's reward may simply be to work on a system that is being completed by the respondents. For example, a job may be to build a database of local knowledge, such as restaurant reviews. While some users may pay for use of the online service, the respondents who are contributing to it may be compensated with the ability to access the service. This compensation scheme may be especially relevant when related to local knowledge outsourcing, where the task relates to learning and verifying locally-relevant information such as prices, locations, ability of services, and the like.

Another type of possible reward to the respondent is to provide the respondent with economic opportunities, rather than or in addition to direct payment to the respondent. For example, the respondent may be given more access to tasks or access to different types of tasks, or the respondent may be given the ability to give friends or acquaintances these opportunities. This may allow the respondent to recruit others (for additional compensation), to train others, to edit the work of others, or to work on more difficult—but better paying—work.

In another embodiment, the compensation may include the ability to vote for something, such on an issue related to tasks and compensation. The more rewarded the respondent, the greater voice that the respondent has in how the issue is resolved. The voting may also be on an issue that has no effect on the respondent, such as an opinion poll.

As mentioned above, respondents may provide information regarding their reward preferences and reward receipt methods at registration. This information can also be updated and revised by the respondents. The feedback and reward information is sent 626 from the server to the respondent device and then displayed 628 to the respondent on the respondent device. The reward is implemented 630 by various methods depending on the type of reward. Rewards may be provided per-response or in the aggregate (e.g., a single reward for all responses sent each week).

A cash reward may be implemented by sending a payment to a respondent's bank account. An airtime reward may be implemented through an interface with an appropriate cellular service provider's account systems. The rewards may be directly paid to an external account for each respondent, or the rewards may be initially added to each respondent's local account that is managed by the server. The respondents may log into the server to manage their accounts, see their account balances (i.e., the money that they've earned), and request to be cashed out. In response to the cash out request, a respondent may direct the payment (e.g., to the respondent's bank account, wireless services account, etc.), and the server then transfers money in accordance with the respondent's instructions. In one embodiment, the payment interface 306 implements the reward.

### Assembling and Providing the Final Result

The server assembles 632 the overall job result from the received task responses. As discussed above, the server may store ordering information regarding the tasks so that the responses can be assembled in the correct order. In one embodiment, the quality of the job result is determined 634 before providing the result to the job provider. The quality of the job result may be determined by applying various algorithms to the known or likely quality of the individual task responses. A determined quality level of the job result may be compared to a threshold quality level for deciding whether the result is of sufficient quality for it to be sent to the job provider. If the result is deemed to be of insufficient quality, further tasks can be sent to respondents as described above to produce a higher quality result.

The job result (e.g., the translated text of a book) is sent 636 to the job provider client 212, which may communicate information summarizing the result and/or the quality of the result to the job provider 102. The job provider client 212 may communicate this information to the job provider 102 using any of a variety of mechanisms. For example, the job provider client 212 may display the information to the job provider 102 in a web-based interface. Alternatively, the job provider client 212 may store the information in a computer-readable medium and make it available for downloading by the job provider 102. The job provider client 212 may even make a hardcopy of the information and send it to the job provider 102. In other embodiments, the information need not be communicated to the job provider 102. For example, the job may involve obtaining information about businesses in a city, and the job provider 102 may just have the job processor 104 update an online directory about the city with the job result. Accordingly, the information about the result may be provided to a third party, or the job result may comprise a performed task that need not result in information to be communicated to the job provider 102 (e.g., where the job is the delivery of a package to a physical address).

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, or it may comprise a general-purpose computing device selectively activated or reconfigured by a computer program stored in the computer. Furthermore, any computing systems referred to in the specification may include a single processor or may be architectures employing multiple processor designs for increased computing capability. Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes rather than to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for performing a job using a distributed group of people, the method comprising:
receiving a job from a job provider;
identifying a hierarchy of tasks for the received job, the tasks comprising a first level task and a second level task for the received job, wherein the first level task comprises a request for a response from a respondent, and the second level task comprises a request that depends on the response from the respondent for the first level task;
delegating the tasks to a plurality of the respondents;
sending the delegated tasks over a network to electronic devices associated with the respondents to whom the tasks are delegated;
receiving responses for the assigned tasks over the network from the electronic devices associated with the respondents to whom the tasks are assigned;
determining a result based on the received responses; and
communicating the result to the job provider.

2. The method of claim 1, wherein the second level task comprises determining whether the received response for the first level task is acceptable.

3. The method of claim 1, wherein the first level task comprises identifying tasks as related tasks if knowledge gained from completing a first task can be applied in completing the second task, wherein the second level task is identified as one of the related tasks, the method further comprises:
identifying a second of the related tasks as another second level task.

4. The method of claim 3, wherein the second level task and the another second level task are both assigned to a same respondent.

5. The method of claim 1, wherein the first level task requires a particular expertise and the second level task does not require the particular expertise.

6. The method of claim 1, wherein the first level task requires an authorization to access confidential data associated with the job, and the second level task does not require the authorization to access confidential data.

7. The method of claim 1, wherein the first level task comprises identifying a respondent with a required skill to complete the second level task.

8. A non-transitory computer readable storage medium storing executable computer program instructions for performing a job using a distributed group of people, the instructions comprising instructions for:
receiving a job from a job provider;
identifying a hierarchy of tasks for the received job, the tasks comprising a first level task and a second level task for the received job, wherein the first level task comprises a request for a response from a respondent, and the second level task comprises a request that depends on the response from the respondent for the first level task;
delegating the tasks to a plurality of the respondents;
sending the delegated tasks over a network to electronic devices associated with the respondents to whom the tasks are delegated;
receiving responses for the assigned tasks over the network from the electronic devices associated with the respondents to whom the tasks are assigned;
determining a result based on the received responses; and
communicating the result to the job provider.

9. The computer readable storage medium of claim 8, wherein the second level task comprises determining whether the received response for the first level task is acceptable.

10. The computer readable storage medium of claim 8, wherein the first level task comprises identifying tasks as related tasks if knowledge gained from completing a first task can be applied in completing the second task, wherein the second level task is identified as one of the related tasks, the instructions further comprising instructions for:
identifying a second of the related tasks as another second level task.

11. The computer readable storage medium of claim 10, wherein the second level task and the another second level task are both assigned to a same respondent.

12. The computer readable storage medium of claim 8, wherein the first level task requires a particular expertise and the second level task does not require the particular expertise.

13. The computer readable storage medium of claim 8, wherein the first level task requires an authorization to access confidential data associated with the job, and the second level task does not require the authorization to access confidential data.

14. The computer readable storage medium of claim 8, wherein the first level task comprises identifying a respondent with a required skill to complete the second level task.

15. A computer system for performing a job using a distributed group of people, the system comprising:
a computer-readable medium storing executable program instructions comprising instructions for:
receiving a job from a job provider;
identifying a hierarchy of tasks for the received job, the tasks comprising a first level task and a second level task for the received job, wherein the first level task comprises a request for a response from a respondent, and the second level task comprises a request that depends on the response from the respondent for the first level task;
delegating the tasks to a plurality of the respondents;
sending the delegated tasks over a network to electronic devices associated with the respondents to whom the tasks are delegated;
receiving responses for the assigned tasks over the network from the electronic devices associated with the respondents to whom the tasks are assigned;
determining a result based on the received responses; and
communicating the result to the job provider.

16. The computer system of claim 15, wherein the second level task comprises determining whether the received response for the first level task is acceptable.

17. The computer system of claim 15, wherein the first level task comprises identifying tasks as related tasks if knowledge gained from completing a first task can be applied in completing the second task, wherein the second level task is identified as one of the related tasks, the instructions further comprising instructions for:
identifying a second of the related tasks as another second level task.

18. The computer system of claim 17, wherein the second level task and the another second level task are both assigned to a same respondent.

19. The computer system of claim 15, wherein the first level task requires a particular expertise and the second level task does not require the particular expertise.

20. The computer system of claim 15, wherein the first level task requires an authorization to access confidential data associated with the job, and the second level task does not require the authorization to access confidential data.

21. The method of claim 1, further comprising:
identifying a hierarchy of respondents, the hierarchy including a first level respondent qualified to complete the first level task and a second level respondent qualified to complete the second level task; wherein
delegating the tasks to the plurality of respondents comprises delegating the first level task to the first level respondent and delegating the second level task to the second level respondent.

22. The method of claim 21, wherein the second level respondent supervises the first level respondent.

23. The method of claim 1, further comprising:
receiving a response for a task from an electronic device of a respondent assigned to the task;
determining that the received response is acceptable; and
providing a reward for the received response to the assigned respondent.

24. The method of claim 1, wherein one of the plurality of tasks includes gathering information about a product or a service.

25. The method of claim 1, wherein one of the plurality of tasks includes sharing information about a product or a service with other people.

26. The method of claim 1, wherein one of the plurality of tasks includes encouraging people to try a product or a service.
